(19) United States
(12) Patent Application Publication
(10) Pub. No.: US 2024/0070497 A1
(43) Pub. Date: Feb. 29, 2024

(54) SYSTEMS AND METHODS FOR TUNING CAPACITANCE IN QUANTUM DEVICES

(71) Applicant: D-WAVE SYSTEMS INC., Burnaby (CA)

(72) Inventor: Richard G. Harris, Vancouver (CA)

(21) Appl. No.: 18/243,280

(22) Filed: Sep. 7, 2023

Related U.S. Application Data
(63) Continuation of application No. 16/996,355, filed on Aug. 18, 2020, now Pat. No. 11,790,259.
(60) Provisional application No. 62/896,996, filed on Sep. 6, 2019.

(51) Int. Cl. G06N 10/00; G06F 15/78; G06N 10/40

(52) U.S. Cl. CPC G06N 10/00; G06F 15/7867; G06N 10/40

(57) ABSTRACT

Quantum processors having qubits with tunable capacitance are provided. The qubits include Josephson junctions shunted by capacitors and are tunably coupled to capacitance loops such that the resonant frequencies of the qubits and capacitance loops avoid entanglement with each other. Methods for tuning the capacitance of such qubits by varying the coupler's coupling strength are provided. These methods include methods for calibrating qubits' capacitance.

### FIELD

This disclosure generally relates to quantum computing, and particularly to the design and operation of devices for tuning the physical characteristics of quantum devices.

### BACKGROUND

### Quantum Devices

Quantum devices are structures in which quantum mechanical effects are observable. Quantum devices include circuits in which current transport is dominated by quantum mechanical effects. Such devices include spintronics, where electronic spin is used as a resource, and superconducting circuits. A superconducting circuit is a circuit that includes a superconducting device. A superconducting device is a device that includes a superconducting material. A superconducting material is a material that has no electrical resistance below critical levels of current, magnetic field, and temperature. Both spin and superconductivity are quantum mechanical phenomena. Superconductivity is a physical phenomenon that was well known in the art at the time of filing of the present application. Quantum devices can be used for measurement instruments, in computing machinery, and the like.

### Quantum Computation

Quantum computation and quantum information processing are active areas of research and define classes of vendible products. A quantum computer is a system that makes direct use of at least one quantum-mechanical phenomenon, such as, superposition, tunneling, and entanglement, to perform operations on data. The elements of a quantum computer are quantum binary digits, known as qubits. Quantum computers hold the promise of providing exponential speedup for certain classes of computational problems such as computational problems simulating quantum physics. Useful speedup may exist for other classes of problems.

One model of quantum computing is adiabatic quantum computing. Adiabatic quantum computing can be suitable for solving hard optimization problems, for example. Further details on adiabatic quantum computing systems, methods, and apparatus are described, for example, in U.S. Pat. Nos. 7,135,701 and 7,418,283.

### Quantum Annealing

Quantum annealing is a computational method that may be used to find a low-energy state of a system, typically preferably the ground state of the system. Similar in concept to classical simulated annealing, the method relies on the underlying principle that natural systems tend towards lower energy states because lower energy states are more stable. While classical annealing uses classical thermal fluctuations to guide a system to a low-energy state, quantum annealing may use quantum effects, such as quantum tunneling, as a source of delocalization to reach an energy minimum more accurately and/or more quickly than classical annealing. In quantum annealing, thermal effects and other noise may be present. The final low-energy state may not be the global energy minimum.

Adiabatic quantum computation may be considered a special case of quantum annealing. In adiabatic quantum computation, the system ideally begins and remains in its ground state throughout an adiabatic evolution. Thus, those of skill in the art will appreciate that quantum annealing systems and methods may generally be implemented on an adiabatic quantum computer. Throughout the present application, any reference to quantum annealing is intended to encompass adiabatic quantum computation unless the context requires otherwise.

### Superconducting Qubits

A quantum processor can be a superconducting quantum processor that includes superconducting qubits. Wendin G. and Shumeiko V. S., “SUPERCONDUCTING QUANTUM CIRCUITS, QUBITS AND COMPUTING” (arXiv:cond-mat/0508729v1, 2005), provides an introduction to the physics and principles of operation of quantized superconducting electrical circuits for quantum information processing.

### Coupling

Couplers can provide communicative coupling between quantum devices in a quantum processor. Coupling can be, for example, between adjacent and/or non-adjacent qubits. Unless expressly indicated otherwise, as used herein and in the claims, the terms couple, couples, coupling and variations of such means direct or indirect communicative coupling or communications between two or more components.

Quantum devices, such as qubits and couplers, may possess various characteristics, such as flux, persistent current, inductance, capacitance, and so on. Such characteristics can affect the results of quantum computations performed by such qubits, and so it can be desirable to tune one or more of those characteristics to align with the parameters of a given computation. Example systems and methods for tuning qubit characteristics, including example qubits and couplers, are provided by U.S. Pat. No. 9,152,923 and PCT Application No. US2018/066613.

The foregoing examples of the related art and limitations related thereto are intended to be illustrative and not exclusive. Other limitations of the related art will become apparent to those of skill in the art upon a reading of the specification and a study of the drawings.

### BRIEF SUMMARY

There exists a need to tune certain physical characteristics of quantum devices, such as capacitance. Aspects of the present disclosure provide a quantum system having qubits with tunable capacitance. The quantum system comprises: a qubit comprising: a qubit loop formed by a first superconducting current path, a first Josephson structure comprising at least one Josephson junction, the Josephson junction interrupting the qubit loop, and a first capacitor shunting the Josephson structure and electrically parallel with the Josephson structure; and a first coupling interface interrupting the qubit loop and electrically parallel with the first capacitor; a capacitance loop comprising a second capacitor and a second coupling interface; and a tunable coupler coupleable to the qubit via the first coupling interface and the coupleable to the capacitance via the second coupling interface.

In some implementations, the first coupling interface comprises a first inductor inductively coupleable to the tunable coupler and the second coupling interface comprises a second inductor inductively coupleable to the tunable coupler, the first and second inductors forming a mutual inductance. In some implementations, the coupler galvanically connects the first coupling interface and the second coupling interface electrically in parallel. In some implementations, the coupler has a maximum ferromagnetic coupling strength below a threshold, the threshold corresponding to an LC-resonant frequency of the coupler outside of a bandwidth of the qubit.

In some implementations, the tunable coupler comprises: a coupler loop coupleable to the first and second coupling interfaces; and a tuning interface interrupting the coupler loop. In some implementations, the tuning interface comprises one or more Josephson junctions. In some implementations, the tuning interface comprises a compound Josephson junction comprising a plurality of Josephson junctions. In some implementations, the system comprises a flux bias operable to bias flux in the tuning interface based on a programming signal.

Aspects of the present disclosure provide a method for tuning an effective capacitance of a qubit in a quantum processor and a system to perform the method. The method is performed by a processor in communication with the quantum processor and comprises: determining a target capacitance for the qubit; determining a predicted capacitance for the qubit; determining a capacitance increment based on the target and predicted capacitances, and based on a capacitance of a capacitance loop; and tuning the effective capacitance of the qubit by causing the quantum processor to assign a coupling strength to a coupler that couples the qubit to the capacitance loop based on the capacitance increment, the resonant frequency of the coupler remaining fixed under variation of the coupling strength.

In some implementations, the method comprises receiving a problem. Determining the predicted capacitance comprises determining a predicted capacitive loading of the qubit based on one or more couplings between the qubit and one or more respective other quantum devices, the one or more couplings based on the problem.

In some implementations, determining the target capacitance comprises retrieving a target capacitance shared by a plurality of qubits including the qubit and determining the capacitance increment comprises determining a difference between the predicted capacitance and the target capacitance. In some implementations, the method comprises determining a respective capacitance increment for each qubit of the plurality of qubits and tuning the effective capacitance of each qubit of the plurality of qubits based on the target capacitance.

In some implementations, causing the quantum processor to assign the coupling strength to the coupler comprises causing the quantum processor to assign the coupling strength to the coupler based on a square root of the capacitance increment.

In some implementations, the method comprises receiving a problem, causing the quantum processor to execute the problem based on the tuning the effective capacitance of the qubit, and receiving from the quantum processor an output state based on the problem and resulting from the causing the quantum processor to execute the problem.

Aspects of the present disclosure provide a computational system, comprising at least one processor in communication with a quantum processor, and at least one nontransitory processor-readable storage medium that stores at least one of processor-executable instructions or data which, when executed by the at least one processor cause the at least one processor to: determine a target capacitance for a qubit of the quantum processor, determine a predicted capacitance for the qubit, determine a capacitance increment based on the target and predicted capacitances and based on a capacitance of a capacitance loop, and tune an effective capacitance of the qubit by causing the quantum processor to assign a coupling strength to a coupler coupling the qubit to a capacitance based on the capacitance increment, a resonant frequency of the coupler remaining fixed under variation of the coupling strength.

In some implementations the at least one of processor-executable instructions or data may further cause the at least one processor to receive a problem and determine a predicted capacitive loading of the qubit based on one or more couplings between the qubit and one or more respective other quantum devices, the one or more couplings based on the problem to determine the predicted capacitance for the qubit, the at least one of processor-executable instructions or data may further cause the at least one processor to retrieve a target capacitance shared by a plurality of qubits including the qubit and determine a difference between the predicted capacitance and the target capacitance to determine the capacitance increment, the at least one of processor-executable instructions or data may further cause the at least one processor to determine a respective capacitance increment for each qubit of the plurality of qubits and tune the effective capacitance of each qubit of the plurality of qubits based on the target capacitance, the at least one of processor-executable instructions or data may further cause the at least one processor to assign the coupling strength to the coupler based on a square root of the capacitance increment, and/or the at least one of processor-executable instructions or data may further cause the at least one processor to receive a problem, cause the quantum processor to execute the problem based on the tuning the effective capacitance of the qubit, and provide an output state based on the execution of the problem.

In some implementations, the features described above may be combined together in any reasonable combination as will be recognized by those skilled in the art.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements and may have been solely selected for ease of recognition in the drawings.

FIG. 1A is a schematic diagram of a prior art qubit.

FIG. 1B is a schematic diagram of a prior art qubit with an inductance tuner.

FIG. 2 is a schematic diagram of an example quantum system comprising a qubit and a capacitive loop coupled by a mutual inductance.

FIG. 3 is a schematic diagram of an example quantum system comprising a qubit and a capacitive loop coupled galvanically by a tunable coupler.

FIG. 4 is a flowchart of an example method for tuning the capacitance of an example quantum system, such as the quantum system of FIG. 3.

FIG. 5 is a flowchart of an example method of another implementation for tuning the capacitance of an example quantum system, such as the quantum system of FIG. 3.

FIG. 6 is a schematic diagram illustrating a computing system comprising a digital computer and a quantum computer.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

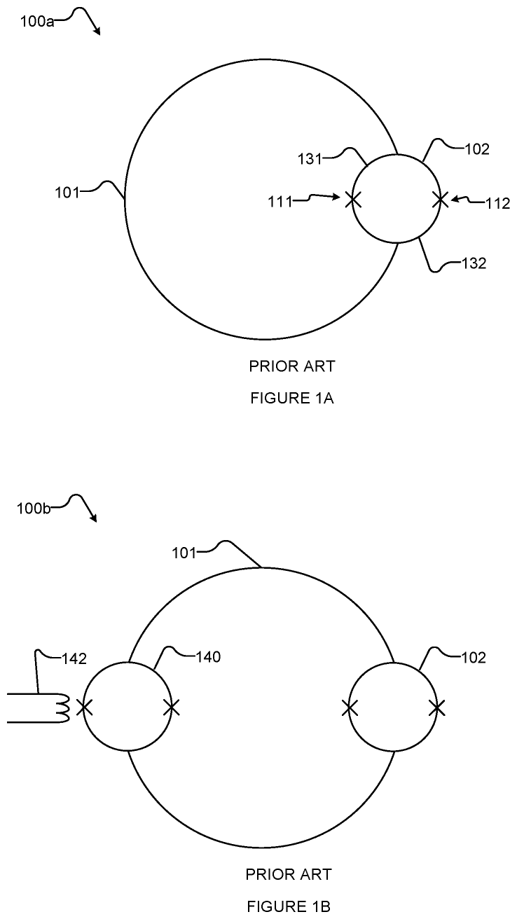

FIG. 1A is a schematic diagram of a superconducting flux qubit 100a. Qubit 100a comprises a first superconducting loop 101 that is interrupted by a second superconducting loop 102, which is itself interrupted by two Josephson junctions 111 and 112. Superconducting loop 101 is referred hereinafter to as the “qubit loop” while superconducting loop 102 is referred to as the compound Josephson junction (“CJJ”) structure. CJJ structure 102 comprises current paths 131, 132, each of which is interrupted by a respective Josephson junction 111, 112.

FIG. 1B is a schematic diagram of a superconducting flux qubit 100b. Qubit 100b comprises first superconducting loop 101 and CJJ structure 102, substantially similarly to qubit 100a. Qubit 100b further comprises an inductance tuner (or “L-tuner”) CJJ structure 140 connected in series with CJJ structure 102 in qubit loop 101. As described, for example, in U.S. Pat. No. 9,152,923, L-tuner CJJ structure 140 may be tuned using a programmable interface 142, such as by inductively coupling control signals to L-tuner CJJ structure 140 and thus tuning the Josephson inductance of L-tuner CJJ structure 140 and, by extension, of qubit 100b.

Qubits 100a and 100b may be coupled to other devices inductively or otherwise. For example, in some implementations, qubits 100a and 100b are inductively coupled to other qubits via inter-qubit couplers (not shown). Such couplings can affect the electromagnetic properties of qubits 100a, 100b. For example, the capacitance of qubit 100b may be a complex function of both coupler and L-tuner settings. Although in the past this effect may have been small enough to ignore in practice, as quantum processors scale up, experiments have shown that the effect may increase. For example, in some implementations, tuning both couplers and L-tuners can cause changes in qubit capacitance on the order of 10 fF, potentially causing errors in calibration, coupler-dependent desynchronization of qubit dynamics, and other difficult-to-address behaviour.

Moreover, it is noted that existing capacitance-tuning techniques (such as the LC circuit of U.S. Pat. No. 9,152,923) can shift the LC-resonant frequency of at least a portion of a qubit's qubit loop to drop within the qubit's bandwidth. This can cause the eigenstates of the qubit to become those of a qubit hybridized with a ladder of harmonic oscillator states (e.g. in the case of a flux qubit). This can make it difficult or impossible to isolate the qubit state from the setting of the capacitance tuner.

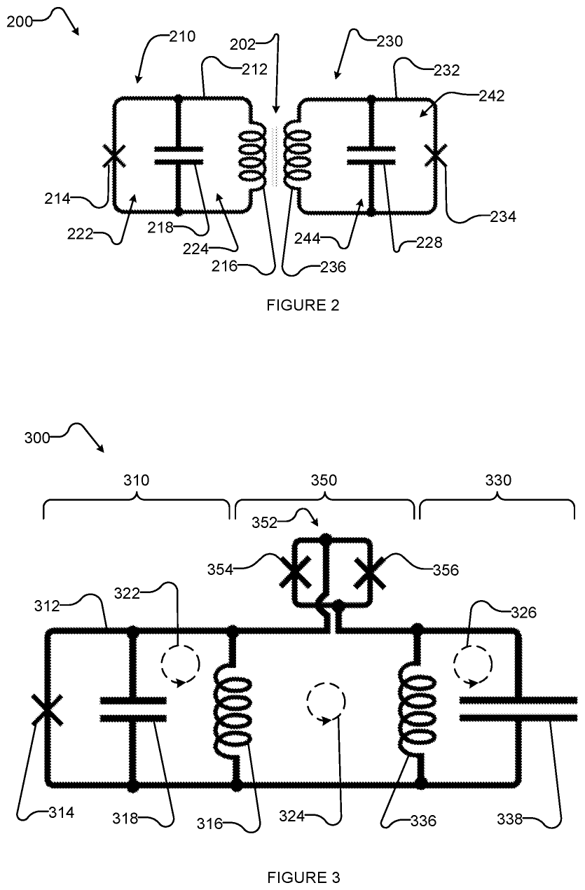

FIG. 2 is a schematic diagram of a quantum system 200 comprising a qubit 210 and a coupler 230. Qubit 210 comprises a qubit loop 212 interrupted by a Josephson structure 214 and a coupling interface 216. Josephson structure 214 comprises at least one Josephson junction and may, for example, comprise a CJJ structure as described above. Josephson structure 214 possesses a critical current I₁^{c}. Coupling interface 216 may, for example, comprise an inductor possessing an inductance L₁. Josephson structure 214 is shunted by capacitor 218 having capacitance C₁.

In at least some implementations, qubit 210 is coupleable to coupler 230 by a mutual inductance 202 having inductance M. In some implementations, coupler 230 comprises a coupler loop 232 interrupted by a Josephson structure 234 and a coupling interface 236. Josephson structure 234 comprises at least one Josephson junction and may, for example, comprise a CJJ structure as described above. Josephson structure 234 possesses a critical current I₂^{c}. Coupling interface 236 may, for example, comprise an inductor possessing an inductance L₂. Josephson structure 234 may be shunted by capacitor 228 having capacitance C₂.

In at least some implementations, the effective capacitance C₁^{eff} of qubit 210 can be described based on the following formula:

$${C}_{1}^{eff} = {C}_{1} + \frac{1}{{( 1 + {β}_{2} )}^{2}} \frac{{M}^{2}}{{L}_{1}^{2}} {C}_{2}$$

where β₂ is a scaling term based on the characteristics of coupler 230. For example, for example coupler 230, β₂ may be described based on β₂=2πL₂I₂^{c}/Φ₀, where Φ₀ is the single flux quantum.

FIG. 3 is a schematic diagram of a quantum computing system 300 comprising a qubit 310 coupleable to capacitance loop 330 via a tunable coupler 350. Qubit 310 may be substantially similar to qubit 210, e.g., comprising a qubit loop 312 interrupted by a Josephson structure 314 and a coupling interface 316. Josephson structure 314 comprises at least one Josephson junction and may, for example, comprise a CJJ structure as described above. Josephson structure 314 possesses a critical current I_{q}^{c}. Coupling interface 316 may, for example, comprise an inductor possessing an inductance M_{co-q}. Josephson structure 314 is shunted by capacitor 318 having capacitance C_{q}.

Capacitance loop 330 comprises a capacitor 338 and a coupling interface 336. Coupling interface 336 may comprise, for example, an inductor possessing an inductance M_{co-r}. In at least some implementations capacitance loop 330 does not require elements such as Josephson structure 234, although such additional and/or alternative elements may optionally be provided.

In at least some implementations, qubit 310 is coupleable to capacitance loop 330 by a tunable coupler 350. In some implementations, coupler 350 is galvanically coupled to qubit 310 and coupler 350, e.g., across coupling interfaces 316, 336. Tunable coupler 350 provides a tuning interface 352. In some implementations, tuning interface 352 comprises a Josephson structure interrupting a coupler loop. For example, in the depicted example implementation of FIG. 3 tuning interface 352 comprises Josephson junctions 354, 356. Tuning interface 352 may be tuned via a programmable interface (e.g., programmable interface 142 as discussed above) that provides a programming signal or via any other suitable technique.

It may be noted that qubit 310, coupler 350, and capacitance loop 330 can be expected to possess respective inductances L_{q} (depicted as 322), L_{co} (depicted as 324), and Lᵣ (depicted as 326).

Coupler 350 may be inductively and/or galvanically coupled to qubit 310 and capacitance loop 330. In some implementations coupler 350 is galvanically coupled to both qubit 310 and capacitance loop 330. In at least some circumstances, such mutually-galvanic couplings can provide stronger maximum coupling strength, smaller physical dimensions, or both relative to all-inductive couplings (such as the all-inductive coupling of the example implementation depicted in FIG. 2).

Coupling interface 336 will tend to cause some inductance shunting through capacitor 338, and therefore there will tend to be LC-resonance associated with capacitance loop 330. However, qubit 310 can be decoupled from capacitance loop 330 by tuning coupler 350 (e.g., by flux biasing tuning interface 352).

Note that, in implementations where a Josephson structure shunted by capacitor 338 (e.g., Josephson structure 234) is tuned, it can be difficult or even impossible to tune capacitance loop 330 without pushing its LC-resonant frequency into the bandwidth of qubit 310, thereby entangling their eigenstates and making it difficult or even impossible (in at least some circumstances) to isolate qubit 310 from capacitance loop 330. At least some implementations of system 300 avoid this problem, including the depicted implementation of FIG. 3, e.g., by tuning a CJJ structure 352 which is not shunted by capacitance loop 330.

In at least some implementations, the resonant frequency of capacitor 338 can be described by:

$${f}_{r} = \frac{1}{2 π {M}_{co - r} {C}_{r}}$$

where Cᵣ is the capacitance of capacitor 338. In at least some implementations, coupling interface 336 and capacitor 338 are provided respective physical characteristics M_{co-r} and Cᵣ such that fᵣ is outside of the bandwidth of qubit 310. For instance, for a qubit 310 with an operational range of 0-5 GHz, coupling interface 336 may comprise an inductor having inductance on the order of M_{co-r}≈50 pH and capacitance loop 330 may comprise a capacitor 338 having capacitance on the order of Cᵣ≈10 pF. (Assuming a maximum coupling strength of M≈10 pH and qubit 310 inductance L_{q}≈300 pH, this implies a reasonably robust tuning range of δC_{q}≈10 fF.) In at least some implementations, this provides a resonant frequency on the order of 7 GHz—just outside the bandwidth of qubit 310.

Coupler 350 may provide ferromagnetic and/or anti-ferromagnetic coupling. In some implementations coupler 350 provides only ferromagnetic coupling. This regime is usually stronger than the anti-ferromagnetic regime (given couplers of similar size), and so can enable smaller devices. However, pushing coupler 350 too deep into the ferromagnetic regime can cause its own LC-resonance to fall within the qubit bandwidth. Accordingly, in at least some implementations coupler 350 provides ferromagnetic coupling with a maximum ferromagnetic coupling strength below a threshold, the threshold corresponding to an LC-resonant frequency of coupler 350 outside of a bandwidth of qubit 310.

The effective capacitance C_{q}^{eff} of qubit 310 can be described, in at least some implementations of system 300, based on the following:

$${C}_{q}^{eff} = {C}_{q} + \frac{{M}^{2}}{{L}_{q}^{2}} {C}_{r}$$

where C_{q} is the capacitance of capacitor 318 of qubit 310, M is the coupling strength of coupler 350 (which may be tunable via tuning interface 352), and L_{q} is the inductance of qubit 310. Qubit 310 may be further coupled to other devices, which may cause capacitive loading and thus affect its effective capacitance. Such capacitive loading may be counteracted (if desired and if practical for the given design and in the given circumstances) by tuning coupler 350 to increase or decrease C_{q}^{eff}, as appropriate.

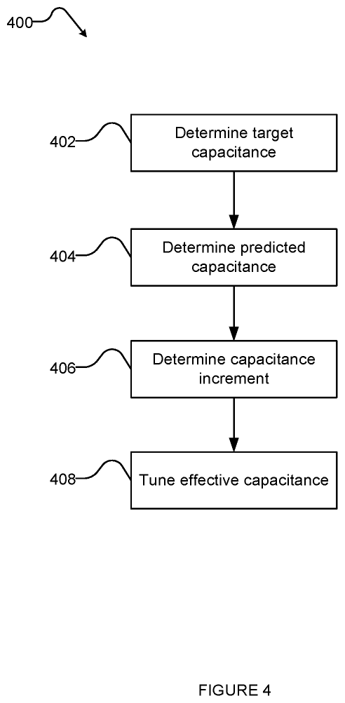

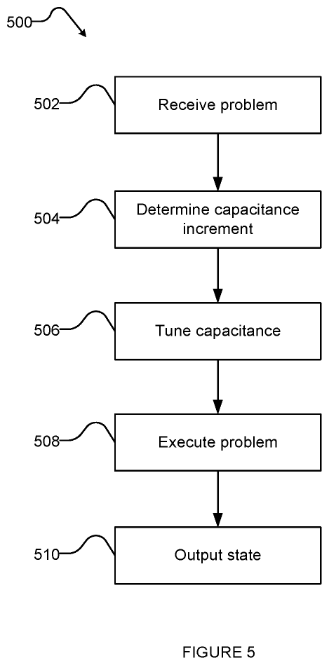

FIG. 4 is a flowchart of a method 400 for tuning the effective capacitance of a qubit. Method 400 may be performed by a computing system (comprising a processor and memory) in communication with a quantum processor. The quantum processor may comprise at least one of the quantum systems 200, 300 described above, and in particular comprises a qubit with tunable effective capacitance.

At 402, the computing system determines a target capacitance for the qubit. In some implementations, determining the target capacitance may comprise retrieving a target capacitance shared by a plurality of qubits (e.g., a calibrated capacitance for each qubit of the plurality of qubits), such that the capacitance increment would bring the qubit's capacitance approximately into alignment with the shared target capacitance.

At 404, the computing system determines a predicted capacitance for the qubit. In some implementations, determining a predicted capacitance comprises retrieving (e.g., from memory, a database, and/or another repository) an intrinsic capacitance of the qubit, e.g., based on a capacitance of a capacitor which the qubit comprises.

At 406, the computing system determines a capacitance increment for the qubit based on the target and predicted capacitances for the qubit and the capacitance of the capacitance loop in communication with the qubit.

At 408, the computing system tunes the effective capacitance of the qubit by causing the quantum processor to assign a coupling strength to the coupler coupling the qubit to the capacitance loop. The assigned coupling strength is determined based on the capacitance increment of act 406. The resonant frequency of the coupler remains fixed under variations of the coupling strength.

Assigning a coupling strength may comprise, for example, the computing system transmitting to the quantum processor a signal causing it to assign a coupling strength of a coupler coupling the qubit to a capacitance loop (e.g., as described above). Such assignment may comprise incrementing or decrementing an existing (and/or default) coupling strength. For example, assigning the coupling strength may comprise loading a flux bias into a tuning interface of the coupler. This is referred to below as assigning capacitance-tuning settings.

In some implementations, tuning the capacitance of the qubit comprises tuning a tunable coupler that is coupled electrically in parallel to both the qubit and the capacitance loop, so as to avoid the entangling of qubit and capacitance loop states mentioned elsewhere herein. Such calibration of qubits' capacitance is not necessarily based on a problem and may instead (or additionally) be directed to calibrating the qubits to have substantially uniform characteristics (namely capacitance). In some implementations, tuning the capacitance of the qubit comprises assigning a coupling strength of the qubit based on the capacitances of the qubit and the capacitance loop. For example, the coupling strength may be assigned proportionately to a square root of the capacitance increment. For example, the coupling strength M may be determined and set based on the following:

$$M = {L}_{q} \sqrt{\frac{{C}_{q}^{t} - {C}_{q}}{{C}_{r}}}$$

where C_{q}^{t} is the target capacitance, C_{q} is the predicted capacitance, and Cᵣ is the capacitance loop's capacitance (e.g., the capacitance of a capacitor interrupting the loop).

FIG. 5 is a flowchart of a method 500 providing one implementation of the method 400 described above. It will be understood that acts 502-510 of method 500 may be included in method 400.

At 502, the computing system receives a problem for execution by the quantum processor. This problem may, for example, comprise a quadratic unconstrained binary optimization problem, a Hamiltonian, a waveform interpretable by the quantum processor, and/or any other suitable representation of a task for computation by the quantum processor.

At 504, the computing system determines a capacitance increment for the qubit. This may, for example, comprise determining a target capacitance for the qubit, determining a predicted capacitance for the qubit based on the problem, and determining the capacitance increment based on a difference between the target and predicted capacitances, as discussed in further detail with respect to method 400. In some implementations, determining a predicted capacitance for the qubit comprises determining a predicted capacitive loading of the qubit based on one or more couplings of the qubit with other devices derived from (and/or encoded by) the problem.

At 506, the computing system causes the quantum processor to tune the capacitance of the qubit, such as by causing the quantum processor to assign a coupling strength to the coupler coupling the qubit to the capacitance loop. As discussed above, calibration of qubits' capacitance may be based on a problem and/or may be directed to calibrating the qubits to have substantially uniform characteristics (namely capacitance).

At 508, the computing system causes the quantum processor to execute the problem while retaining the capacitance-tuning settings assigned at 506. At 510, the computing system receives from the quantum processor an output state resulting from the execution of the problem based on those capacitance-tuning settings.

Methods 400 and 500 may be performed by a computational system as discussed above. In some implementations, a computational system for performing methods 400 and 500 may include at least one processor in communication with a quantum processor, and at least one nontransitory processor-readable storage medium that stores at least one of processor-executable instructions or data, which, when executed by the at least one processor cause the at least one processor to implement method 400 or method 500.

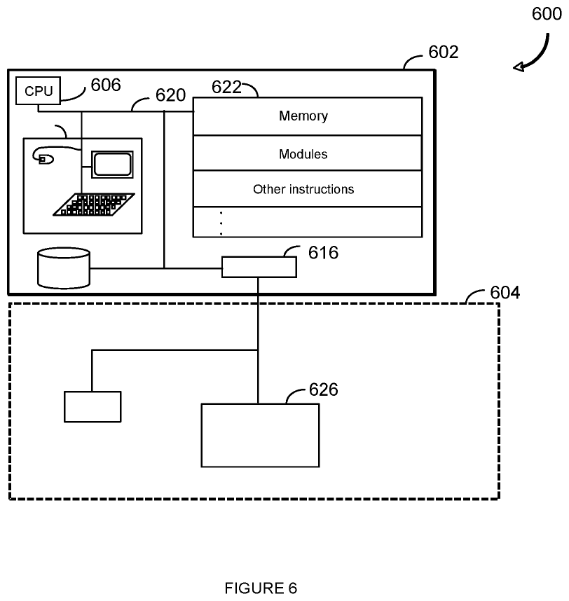

One implementation of a computational system 600 that may perform method 400 or method 500 is shown in FIG. 6. FIG. 6 illustrates a computational system 600 having a digital processor 606 and a quantum processor 626.

Classical computer 602 includes one or more digital processors 606 and may further include at least one system memory 622, and at least one system bus 620 that couples various system components, including system memory 622 to digital processor(s) 606. System memory 622 may include at least one nontransitory processor-readable storage medium that stores at least one of processor-executable instructions or data.

Digital processor(s) 606 may be any logic processing unit or circuitry (for example, integrated circuits), such as one or more central processing units (“CPUs”), graphics processing units (“GPUs”), digital signal processors (“DSPs”), application-specific integrated circuits (“ASICs”), programmable gate arrays (“FPGAs”), programmable logic controllers (“PLCs”), etc., and/or combinations of the same.

In some implementations quantum computer 604 includes a quantum processor 604 with at least one superconducting integrated circuit that includes microwave sensitive components within microwave shielding layers, components fabricated with low noise dielectrics, and other components fabricated using systems and methods described in the present application. Quantum processor 626 may include at least one qubit with a tunable effective capacitance as described in greater detail herein. Quantum computer 604 may communicate with classical computer 602 via, for instance, a controller 616. Certain computations may be performed by quantum computer 604 at the instruction of digital computer 602, as described in greater detail herein. Quantum computer 604 may include other components, such as control systems and readout systems, that communicate with quantum processor 626.

The above described method(s), process(es), or technique(s) could be implemented by a series of processor readable instructions stored on one or more nontransitory processor-readable media. Some examples of the above described method(s), process(es), or technique(s) method are performed in part by a specialized device such as an adiabatic quantum computer or a quantum annealer or a system to program or otherwise control operation of an adiabatic quantum computer or a quantum annealer, for instance a computer that includes at least one digital processor. The above described method(s), process(es), or technique(s) may include various acts, though those of skill in the art will appreciate that in alternative examples certain acts may be omitted and/or additional acts may be added. Those of skill in the art will appreciate that the illustrated order of the acts is shown for exemplary purposes only and may change in alternative examples. Some of the exemplary acts or operations of the above described method(s), process(es), or technique(s) are performed iteratively. Some acts of the above described method(s), process(es), or technique(s) can be performed during each iteration, after a plurality of iterations, or at the end of all the iterations.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied to other methods of quantum computation, not necessarily the exemplary methods for quantum computation generally described above.

The various implementations described above can be combined to provide further implementations. All of the commonly assigned US patent application publications, US patent applications, foreign patents, and foreign patent applications referred to in this specification and/or listed in the Application Data Sheet are incorporated herein by reference, in their entirety, including but not limited to:
U.S. Pat. No. 7,135,701
U.S. Pat. No. 7,418,283
U.S. Pat. No. 9,152,923
PCT Application No. US2018/066613
U.S. Provisional Application Nos. 62/896,996; 62/608,501 and 62/693,305

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1-8. (canceled)

9. A method for tuning an effective capacitance of a qubit in a quantum processor, the qubit having an operational bandwidth, the method performed by a processor in communication with the quantum processor and comprising:
determining a target capacitance for the qubit;
determining a predicted capacitance for the qubit;
determining a capacitance increment based on the target and predicted capacitances, and based on a capacitance of a capacitance loop, the capacitance loop having a resonant frequency that is outside the operational bandwidth of the qubit; and
tuning the effective capacitance of the qubit by causing the quantum processor to apply a coupling strength to a coupler coupling the qubit to the capacitance loop based on the capacitance increment, a resonant frequency of the coupler remaining fixed under variation of the coupling strength.

10. The method according to claim 9 comprising receiving a problem and wherein determining the predicted capacitance comprises determining a predicted capacitive loading of the qubit based on one or more couplings between the qubit and one or more respective other quantum devices, the one or more couplings based on the problem.

11. The method according to claim 9 wherein determining the target capacitance comprises retrieving a target capacitance shared by a plurality of qubits including the qubit and determining the capacitance increment comprises determining a difference between the predicted capacitance and the target capacitance.

12. The method according to claim 11 comprising determining a respective capacitance increment for each qubit of the plurality of qubits and tuning the effective capacitance of each qubit of the plurality of qubits based on the target capacitance.

13. The method according to claim 9 wherein causing the quantum processor to apply the coupling strength to the coupler comprises causing the quantum processor to apply the coupling strength to the coupler based on a square root of the capacitance increment.

14. The method according to claim 9 further comprising:
receiving a problem;
causing the quantum processor to execute the problem based on tuning the effective capacitance of the qubit; and
receiving from the quantum processor an output state based on the problem and resulting from causing the quantum processor to execute the problem.

15. A computational system, comprising:
at least one processor in communication with a quantum processor; and
at least one nontransitory processor-readable storage medium that stores at least one of processor-executable instructions or data which, when executed by the at least one processor cause the at least one processor to:
determine a target capacitance for a qubit of the quantum processor, the qubit having an operational bandwidth;
determine a predicted capacitance for the qubit;
determine a capacitance increment based on the target and predicted capacitances and based on a capacitance of a capacitance loop, the capacitance loop having a resonant frequency that is outside the operational bandwidth of the qubit; and
tune an effective capacitance of the qubit by causing the quantum processor to apply a coupling strength to a coupler coupling the qubit to a capacitance based on the capacitance increment, a resonant frequency of the coupler remaining fixed under variation of the coupling strength.

16. The computational system of claim 15 wherein the at least one of processor-executable instructions or data further cause the at least one processor to receive a problem and determine a predicted capacitive loading of the qubit based on one or more couplings between the qubit and one or more respective other quantum devices, the one or more couplings based on the problem to determine the predicted capacitance for the qubit.

17. The computational system of claim 15 wherein the at least one of processor-executable instructions or data further cause the at least one processor to retrieve a target capacitance shared by a plurality of qubits including the qubit and determine a difference between the predicted capacitance and the target capacitance to determine the capacitance increment.

18. The computational system of claim 17 wherein the at least one of processor-executable instructions or data further cause the at least one processor to determine a respective capacitance increment for each qubit of the plurality of qubits and tune the effective capacitance of each qubit of the plurality of qubits based on the target capacitance.

19. The computational system of claim 15 wherein the at least one of processor-executable instructions or data further cause the at least one processor to apply the coupling strength to the coupler based on a square root of the capacitance increment.

20. The computational system of claim 15 wherein the at least one of processor-executable instructions or data further cause the at least one processor to:
receive a problem;
cause the quantum processor to execute the problem based on the tuning the effective capacitance of the qubit; and
provide an output state based on the execution of the problem.

21. The method according to claim 9 wherein determining a predicted capacitance for the qubit comprises retrieving an intrinsic capacitance of the qubit based on a capacitance of a capacitor of the qubit.

22. The method according to claim 9 wherein causing the quantum processor to apply the coupling strength to the coupler comprises causing the quantum processor to load a flux bias into a tuning interface of the coupler.

23. The method according to claim 9 wherein tuning the effective capacitance of the qubit by causing the quantum processor to apply a coupling strength to a coupler coupling the qubit to the capacitance loop comprises tuning the effective capacitance of the qubit by causing the quantum processor to apply a coupling strength to a coupler that is coupled electrically in parallel to both the qubit and the capacitance loop.

24. The computational system of claim 15 wherein the predicted capacitance for the qubit comprises an intrinsic capacitance of the qubit based on a capacitance of a capacitor of the qubit.

25. The computational system of claim 15 wherein causing the quantum processor to apply the coupling strength to the coupler comprises causing the quantum processor to load a flux bias into a tuning interface of the coupler.

26. The computational system of claim 15 wherein the coupler is coupled electrically in parallel to both the qubit and the capacitance loop.
